(19) United States
(12) Patent Application Publication
(10) Pub. No.: US 2008/0085823 A1
(43) Pub. Date: Apr. 10, 2008

(54) Method for Making a Bag

(76) Inventor: Marco Reggi, Piacenza (IT)

Correspondence Address: YOUNG & THOMPSON, 745 SOUTH 23RD STREET, 2ND FLOOR, ARLINGTON, VA, 22202, US

(21) Appl. No.: 11/793,728

(22) PCT Filed: Dec. 13, 2005
(86) PCT No.: PCT/IB05/03954

§ 371 Date: Jun. 21, 2007

(30) Foreign Application Priority Data
Dec. 23, 2004 (IT) MI2004A002491
Apr. 21, 2005 (IT) BO2005A000265

(51) Int. Cl. B31B 1/64

(52) U.S. Cl. 493/189

(57) ABSTRACT

A method for making bags from flexible plastic film comprises the steps of feeding a sheet of plastic film; making at least one indented pleated portion in the film and, in particular, a first and a second indented pleated portion (916, 918), and e forming the film into a tubular shape. According to the method of the invention, means are provided for sealing the respective end (916′, 918′) of the pleated portion, said means being in the form of a respective sealing band (942).

### TECHNICAL FIELD

This invention relates to a method for making a bag, preferably a bag of flexible plastic film.

The bag made with the method according to the invention is designed to be used in particular, but not exclusively, for the packaging of foodstuffs, including pet foods.

### BACKGROUND ART

In this sector, bags made of layered plastic to contain products of different kinds, especially food products, are known. These bags comprise a front face, a rear face and side faces in the form of respective V-shaped pleats.

The bags have at the top of them a tubular mouth without pleated parts and which can be opened and closed by suitable means, consisting of a zip, extending across the full width of the bag.

The bag normally has images and writing printed all around it, on its front, rear and side faces.

In a prior art method for making a bag of this kind, a web of plastic film to form the front or rear face of the bag is fed lengthways and a continuous strip of material to form the zip fastener is fed at a suitable distance from one of the longitudinal edges of the web and in a direction parallel to said longitudinal edges.

A large sheet is cut from the web fed in lengthways to form one of the bag's main walls and is joined to another large sheet to form the bag's opposite main wall. At the same time, smaller lengths of film to form the pleated side walls of the bag are fed in transversally and placed between the upper and lower large sheets.

This method of making the bag, however, requires a large number of rolls of film on which respective printing operations are performed. In practice, an extremely large number of operations are required to print images and writing on the sides of the film web that will form the front, rear and pleated side faces of the bag. As a result, bags of this kind are expensive to produce and not always good quality. Indeed, the process of assembling all the parts of the bag is a tricky one and often leads to badly made, poor quality bags.

In another prior art method, a single web of printed film is fed in. This sheet has transversally aligned openings made in it along the longitudinal zones or portions of the film to form the side pleats of the bag. The sheet of film is then folded into a tubular shape by joining its longitudinal end edges after a zip or other suitable means for opening and closing the bag has been positioned transversally between the above mentioned transversally aligned openings. Once the film has been folded and sealed into a tubular shape, suitable V-shaped side portions to form the pleated side faces of the bag are provided and a series of transversal seals are made in the tube, each forming the bottom of a bag when the tube is cut into separate bags as it advances.

The quality of bags made using the prior art method just described, however, is not optimum. This is because the transversally aligned openings weaken the structure of the film, creating edges and surfaces that tend to move out of line and form creases as the film advances and often resulting in misalignment between the different parts of the bag.

Moreover, in some prior art bags, the zip is designed to hermetically seal the pleats or, in other types of bag, suitable seals and folds are made at the ends of the pleats to be closed.

In bags of the former type, the provision of a zip on the pleated sides, though advantageous, restricts the range of bag forms that can be made to meet the requirements of bag users. That is because the zip must necessarily be applied to the upper edges of the pleats to be closed. Moreover, to be applied effectively, the fastening strips making up the zip require large supporting surfaces or flaps, which increases the amount of material needed to make the bag and raises production costs considerably.

The other types of bag with the folds and seals at the upper edges of the pleats, on the other hand, are complicated and awkward to make.

According to one advantageous aspect of it, this invention provides a method for making bags, preferably of flexible plastic film, comprising steps of feeding a sheet of film, preferably of a suitable plastic material; making in said film at least one indented pleated portion and, in particular, a first and a second indented pleated portion, where each indented pleated portion has a respective end, and forming the film into a tubular shape; the method being characterised in that means are provided for sealing the respective end of the pleated portion; and in that said means for sealing the respective end of the indented pleated portion are in the form of a respective sealing band.

In this way, the means for sealing the pleats can be applied very easily and without restricting the range of bag shapes that can be made. Further, the cost of obtaining the closure of the pleats is particularly low.

Other advantageous aspects of the method according to the present invention are described in the other claims.

### BRIEF DESCRIPTION OF THE DRAWINGS

The technical characteristics of the bag and method according to the invention are clearly described in the claims below and their advantages are apparent from the detailed description which follows, with reference to the accompanying drawings which illustrate preferred non-restricting embodiments of the invention and in which:

FIG. 1 is a perspective view showing a first preferred embodiment of the bag in the flattened condition;

FIG. 2 is a perspective view showing the first preferred embodiment of the bag when filled;

FIG. 3 is a perspective view showing the first preferred embodiment of the bag when filled and open;

FIG. 4 is a perspective view of a second preferred embodiment of the bag in the full, open condition;

FIG. 5 shows a sheet of film used to make bags according to a first preferred embodiment of the invention;

FIG. 6 is a cross section of the sheet of film through the plane II-II of FIG. 5;

FIG. 7 is a cross section of a bag being made according to the first preferred embodiment of the method according to the invention;

FIG. 8 is a cross section through line VII-VII of FIG. 9, during a step of sealing the zip in the first preferred embodiment of the method;

FIG. 9 represents a bag web made according to the first preferred embodiment of the method according to the invention;

FIG. 10 to 18 illustrate the different steps of making the bag according to a second preferred embodiment of the method for making flexible bags;

FIG. 19 is a perspective view of a significant portion of the film made according to a third preferred embodiment of the method for making bags from flexible plastic film;

FIG. 20 is a perspective view of a portion of the film made according to a fourth preferred embodiment of the method for making bags from flexible plastic film;

FIG. 21 is a perspective view of a bag web made according to a fifth preferred embodiment of the method for making bags from flexible plastic film;

FIG. 22 is a perspective view of a flat sheet of film obtained according to a sixth preferred embodiment of the method for making bags from flexible plastic film;

FIG. 23 is a perspective view of a bag web made according to a seventh preferred embodiment of the method for making bags from flexible plastic film;

FIG. 24 is a perspective view of a bag web made according to an eighth preferred embodiment of the method for making bags from plastic or flexible film;

FIG. 25 illustrates a bag web made according to a ninth preferred embodiment of the method for making bags from plastic or flexible film;

FIG. 26 to 35 illustrate the different steps of making bags according to a tenth preferred embodiment of the method for making flexible bags;

FIG. 36 to 40 illustrate the different steps of making bags according to an eleventh preferred embodiment of the method according to the invention.

### DESCRIPTION OF THE PREFERRED EMBODIMENTS OF THE INVENTION

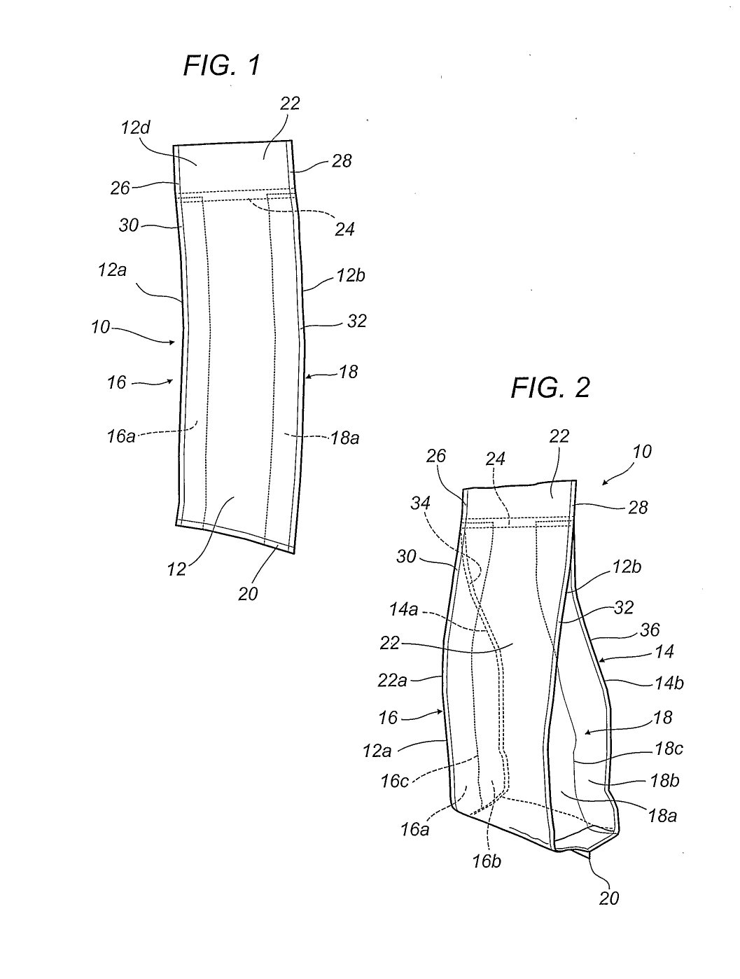

FIGS. 1 to 3 illustrate a preferred embodiment 10 of a bag made from plastic film according to a first preferred embodiment of the method according to the invention.

As shown in the drawings, the bag 10 comprises a front wall 12, a rear wall 14 and opposite side walls 16, 18, made in such a way as to form generally V-shaped pleats.

As illustrated, the pleats or side walls 16 and 18 consist of respective longitudinal portions 16a, 16b and 18a, 18b that extend from respective edges 12a, 14a and 12b, 14b of the front and rear walls 12 and 14. The reference numerals 16c and 18c, in particular in FIG. 2, denote the longitudinal folding or separating edges between the indented pleated portions or panels 16a, 16b and 18a, 18b.

The bottom of the bag 10 is made by joining or sealing opposite transversal ends of the front and rear walls 12, 14. This bottom seal is labelled 20 in the drawings.

As shown in FIG. 2, when the bag is full, the lower portions or zones of the front and rear walls 12, 14 contribute to forming the bottom of the bag.

In another embodiment, not illustrated in the drawings, a bottom portion of the bag might be folded in such a way as to overlap the rear wall 14, thus giving the bag an enlarged or flat bottom in which the lower portion of the wall 12 forms the lower transversal face of the bag when full. In this condition, the lower portion of the bag, which is folded over the rear wall, is pressed against and glued to the respective portion of the rear wall in a manner well within the knowledge of an expert in the trade and therefore not described in further detail.

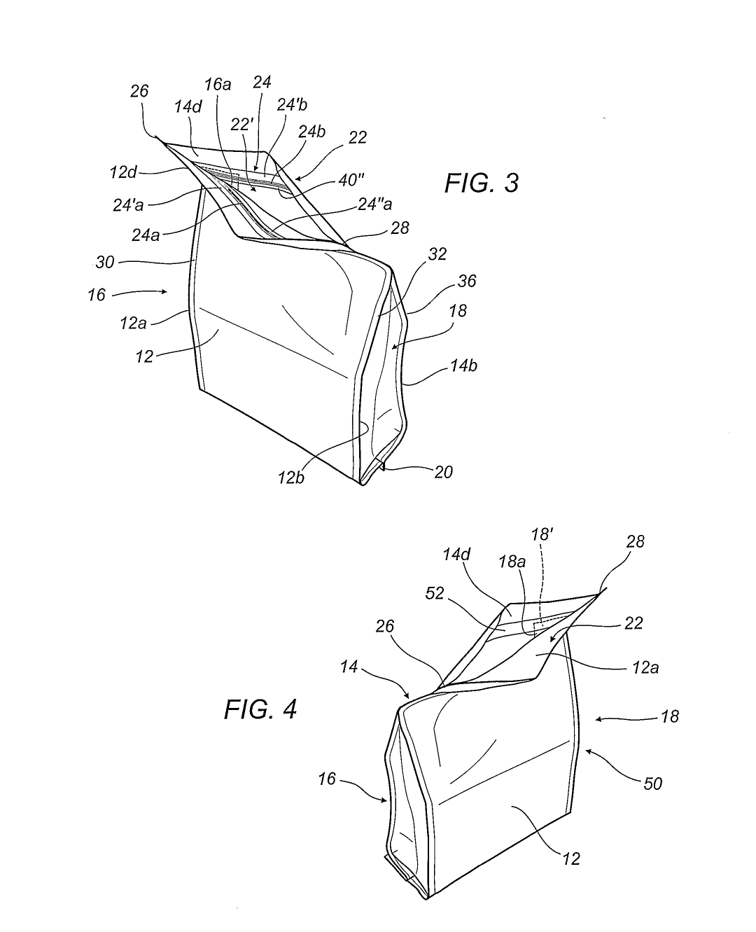

At the top, the bag has a product inlet opening 22′ defined by a tubular collar or mouth 22 without pleated parts, as shown clearly in FIG. 3.

In practice, the mouth is formed by opposite upper ends 12d, 14d of the front and rear walls 12, 14.

Means 24 are provided for opening and closing the mouth 22′ and consisting, in particular, of a zip comprising a first fastening element 24a, on the wall 12, and a second fastening element 24b, on the rear wall 14, that can be reciprocally engaged and disengaged.

As illustrated, in this preferred embodiment of the bag, the first fastening element 24a is connected to the respective wall by an upper flap 24′a and a lower flap 24″a, whilst the second fastening element 24b is in turn connected to the respective wall 14 by a respective upper flap 24′b. These connecting flaps or strips are preferably sealed to the respective walls 12 and 14 of the bag.

The fastening elements 24a and 24b may, however, be of any suitable type within the knowledge of an expert in the trade and made in such a way as to be easily disengaged and engaged by pulling the upper portions 12d and 14d of the front and rear faces 12 and 14 apart to open the bag and pressing the portions 12d, 14d together again to close it.

As illustrated in FIGS. 1 to 3, there are lateral seals or joins 26, 28 at the top 22 of the bag and seals or joins 30, 32, 34, 36 on the extension of the seals 26, 28, at the connecting edges 12a, 12b and 14a and 14b of the front wall 12 and rear wall 14, respectively, to join the portions 12d, 14d with the pleated sides of the bag.

FIG. 4 illustrates a second preferred embodiment 50 of the bag. The parts of the second embodiment of the bag that are the same as those of the first embodiment described above are denoted by the same reference numerals and, for brevity, will not be described in detail again.

Like the first preferred embodiment, the bag 50 comprises pleated sides 16, 18 having respective upper ends, only the upper end 18′ of the pleated side 18 being shown in FIG. 4. In this second preferred embodiment, the upper end of the pleats is closed by a strip or band 52, preferably of heat-sealable material, especially a material that is heat-sealable on both sides or faces.

The band 52 is suitably glued or sealed above the upper ends of the pleats 16, 18 which are folded against a respective wall of the bag or, more specifically, in this embodiment, against the wall 14. The band 52 is also glued or sealed to the respective wall 14 of the bag.

This second bag embodiment might also comprise means for opening and closing the upper mouth 22′, in particular in the form of a zip. The zip might be applied above and in contact with the band 52 or in a position longitudinally spaced from the band 52, in particular in a position above the latter, or even below it. In practice, in this embodiment, the zip would not be used to close the upper end of the pleats but would constitute simple opening/closing means allowing access to the inside of the bag on successive occasions.

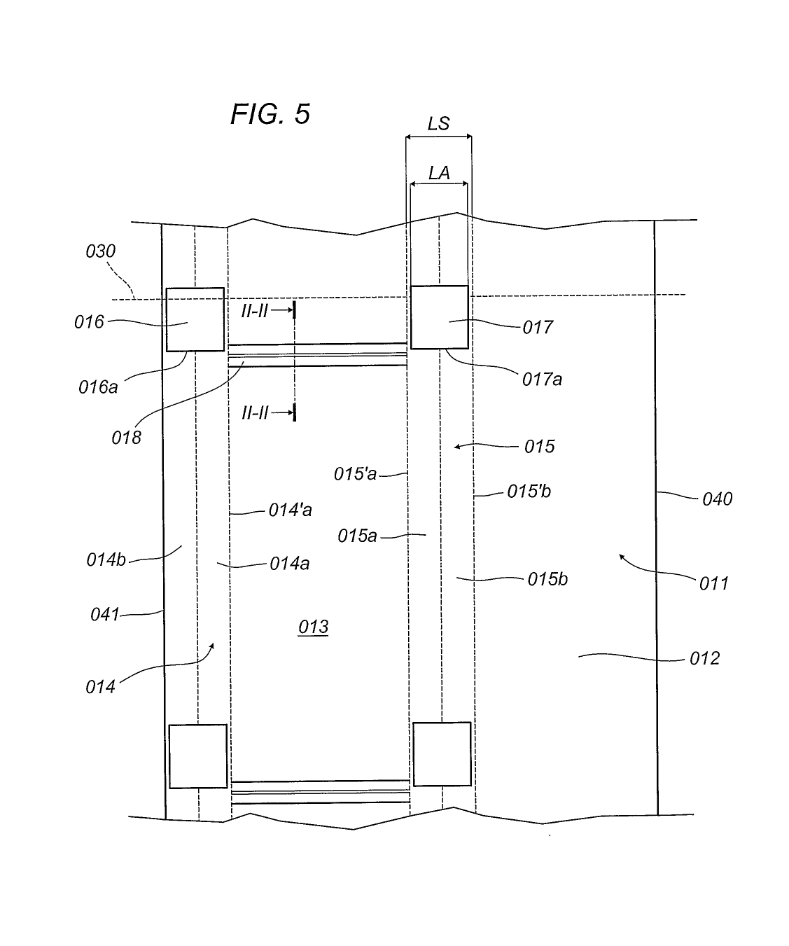

FIGS. 5 to 9 illustrate the different steps of a first preferred method, in particular to make the first embodiment of the bag described above.

FIG. 5 shows a sheet 011 of plastic film designed to be used to make a re-closable bag with pleated sides. The bag might be used to package food products, for example pet food. The plastic film advantageously has at least two layers; an inner layer made of a material suitable for sealing and an outer layer made of a material not suitable for sealing but designed to have images and writing printed on it.

The sheet 011 is designed to be folded lengthways so that the portion 013 forms the first wall (or front wall) of the bag, while two longitudinal areas 014 and 015 form the two V-shaped pleated sides of the bag and a portion 012 (equal in width to the first wall) forms the second wall (or rear wall) of the bag. As shown in FIG. 1 (where the longitudinal fold lines of the sheet are, for clarity, drawn in dashed line style), the portion 013 is located between the two areas 014 and 015 used to form the pleated sides of the bag. One longitudinal end 041 of the sheet 011 corresponds to an edge of the band 014, whilst the other longitudinal end 040 of the sheet 011 corresponds to an edge of the portion 012 that will form the rear wall. Each of the areas 014 and 015 comprises two parts 014a, 014b and 015a, 015b, respectively, which form the two wings of the V-shaped pleats. After being folded, the two lateral ends or edges 040, 041 of the sheet are sealed to each other to form the tube from which a bag web will be made by transversal sealing and cutting. The transversal cutting area where the bags are separated from each other is schematically indicated by the dashed line 030. According to the invention, pairs of rectangular openings 016 and 017 are made in the areas 014 and 015 that will form the pleated sides. The two openings in each pair are aligned with each other in a direction transversal to the strip 011 and are close to the upper end of the respective bag.

A zip 018 is applied to the inside face of the wall 013 and extends transversally between the two areas forming the pleats and so that its ends are close to the lower edges 016a and 017a of each opening 016, 017, as explained in more detail below.

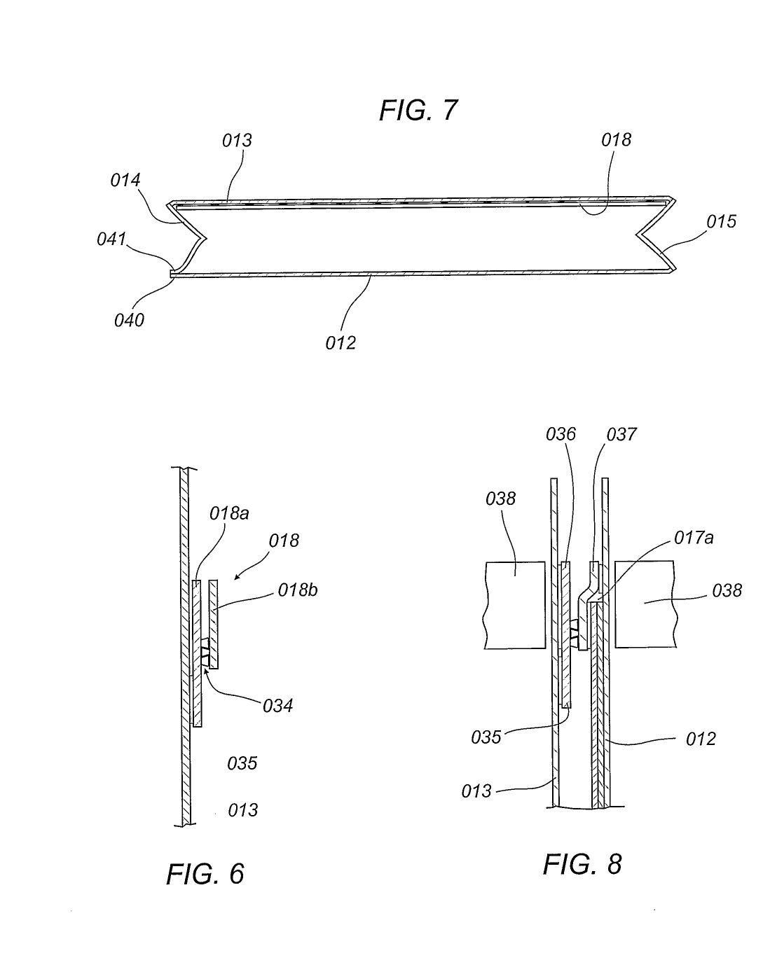

As shown clearly in FIG. 6, the zip 018, which is of substantially known type, comprises two parts (or strips) 018a and 018b of plastic material sealed to the two opposite walls of the bag and equipped with interlocking means 034 by which the bag can be closed or opened.

It should be noted that the zip can be applied and the openings 016, 017 formed in any order.

Advantageously, the part 018a that is sealed to the wall 013 is wider than the part 018b, as shown in the cross section of FIG. 6. That means the zip 018 can be sealed to the wall 013 first of all only by the bottom section 035 of the strip 018a that extends below the narrower strip 018b.

Once the openings 016, 017 have been made and the part 035 of the zip 018 has been sealed to the wall 013, the sheet 011 can be folded to make the continuous tube sealed along the edges 040, 041 according to methods for making bags from a web of film which are well within the knowledge of an expert in the trade and which are therefore not further described or illustrated herein.

The pleated portions folded inwards into the shape of a V are also formed using known methods during folding operations.

The two walls 012 and 013 are thus positioned face to face and the zip 018 inside the tube, as shown schematically in FIG. 3, which represents a cross section of the tube in the vicinity of the zip.

Advantageously, the folds between the pleats and the walls may also be sealed to keep them in place.

Once the tube has been formed and the pleated sides folded, the zip may be fully sealed in place.

As shown in FIG. 8, two customary transversal sealing blades 038 heat the seal at the height of the two areas 036 and 037 of the zip which are positioned face to face and not yet sealed to each other. As is usual in the trade, the material which the two parts of the zip are made of cannot be sealed to itself but can be sealed with the material of the inner layer of the bag. The two areas 036 and 037 of the zip are thus sealed to the respective walls of the bag and the zip is thus fully assembled.

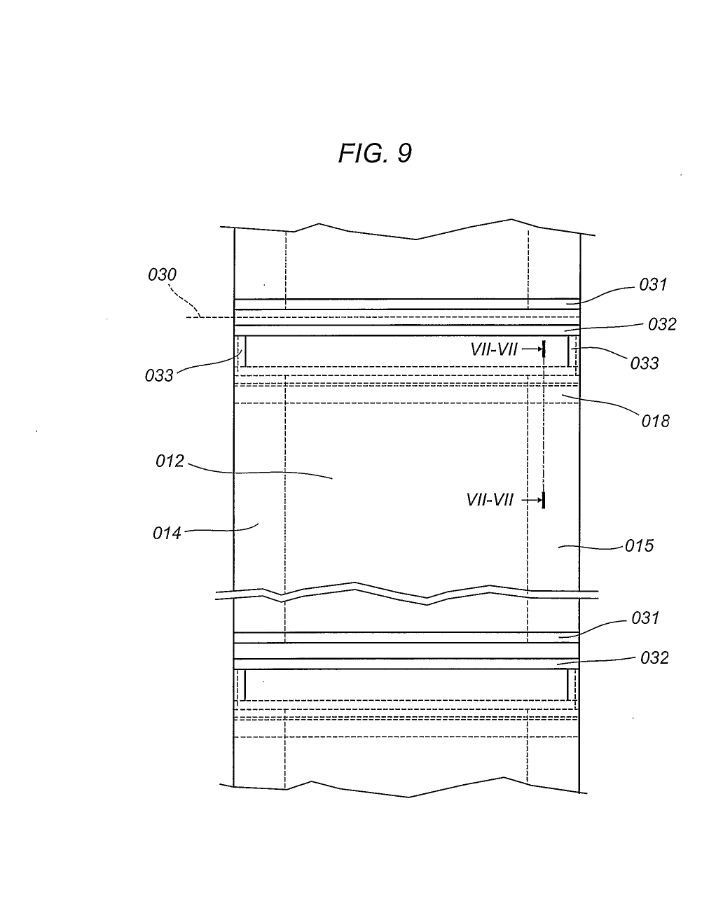

As shown in FIGS. 8 and 9, the upper area 037 of the zip is placed across the edges 016a and 017a of the openings that break the tops of the pleated sides. The sealing of these areas thus transversally closes the upper, open part of the pleat. It should be noticed that the open upper edges of the pleated portion could not be sealed directly because they are in contact with each other's outer faces which are made of non-sealable material.

As shown in FIG. 9, a continuous transversal seal 031 is also made in the vicinity of the cutting line 030 between the bags at the bottom of each bag in order to close the bottom of the bag itself.

Advantageously, as clearly shown in FIG. 9, the top of each pair of rectangular openings 016, 017 may extend a little way (for example approximately one centimetre) past the transversal cutting area in such a way as to be included in the transversal seal that closes the bag above the bag to which they belong. This makes it possible to seal together the two bottom “fins” of each pleat so that the base of the bag, once the bag has been filled, is more stable. In prior art, sealing the fins in this way is not possible when multi-layer film is used because it would have to be applied between the outer faces of the bag, which are usually made of non-sealable material. Prior art therefore requires an additional gluing step which complicates machine construction and raises the cost of the bag.

Once the bag has been filled, a final transversal seal 032 between the upper edge of the bag and the zip fully seals the bag. To open the bag for the first time, it is sufficient to cut it transversally between the upper seal 032 and the zip. The zip can then be used to close it on subsequent occasions.

Obviously, the zip may be finally sealed and the bag mouth and bottom transversally sealed during the same production stage as that in which the bags are separated from each other by cutting, or these operations may be carried out at different stages, depending entirely on specific packaging requirements. Thus, for example, the bags might be made at a bag production station and then filled and sealed at a later stage at a completely different filling station. The pleated sides might also be formed either before or after the juxtaposition and reciprocal sealing of the film web.

In one preferred embodiment, the zip is fully assembled and the bag bottoms sealed and cut so as to obtain separate bags to be filled at a later stage. This is convenient when finished bags have to be supplied to a filling company that wishes to minimise the operations it has to perform on the bags. With the bags separated and open at the top, all that needs to be done to obtain a finished product is fill each bag and apply a single seal transversally across the top of it.

It is obvious, however, that the bags made according to the invention may if necessary be filled in process during their production: when this is the case, the bottom of the last bag in the tube of film is sealed, the bag filled, the zip fully assembled and sealed, the top of the bag transversally sealed and the bag separated from the tube along the transversal cut 030, after which the process is repeated on the next bag, and the next and so on.

Still with reference to FIG. 9, whichever process is followed, further longitudinal side seals 033 may be made to improve the quality of the bag seal and to better define the mouth through which the product can be poured out of the bag.

As illustrated in FIG. 5, in this preferred embodiment, the width “LA” of the openings 016, 017 is less than the transversal distance “LS” between the fold lines 041, 014′a and 015′a, 015′b of the film portions 014, 105 that define a respective pleated side of the bag. Thus, the openings are smaller and less likely to weaken the film being fed along the production line, making film feed more stable and allowing better quality bags to be made.

Those familiar with the trade will no doubt appreciate that the bags according to the invention are functional and convenient to use and that the method for making them is at once simple, fast and inexpensive. Filling the bag through the easy-to-open mouth is also quick and easy, especially when automatic machinery is used. The sealing operations required after filling are reduced to a minimum.

Moreover, the strength of the bag is comparable to that of a zipless bag that is sealed all around. The internal zip has no sealing function until the bag is opened for the first time by cutting (or, if customary tearing means are provided, by tearing).

Using the full bag is also easier: the re-closable mouth of the bag extends for the full width of the bag, making it easier to pour the product out of it. Also, since the position of the mouth between the front and rear walls of the bag (and not on a single wall) and its acute-angled edge make it very easy to pour products that are in granular form.

Alternatively, the zip might, initially, be applied symmetrically also to the second bag wall and not, as described, to the first wall between the two strips forming the pleats. It might also be advantageous to make the pleats first and to seal a part of the zip over them so that the zip overlaps the lower edge of the openings in the pleats, and to then seal the second part of the zip to the opposite wall. In practice, this might be done by sealing the part 018a in place of the part 018b to the wall 012 with the pleats already formed (as shown for example, in FIG. 8) and then sealing the part 018a to the wall 013, with the added advantage of being able to use the wider part of the zip to close the opening in the pleated portions defined by the edges 016a and 017a. In yet another embodiment, one of the two walls of the bag might also be made from a separate sheet of film superposed and sealed to the other sheet on which the pleats are made.

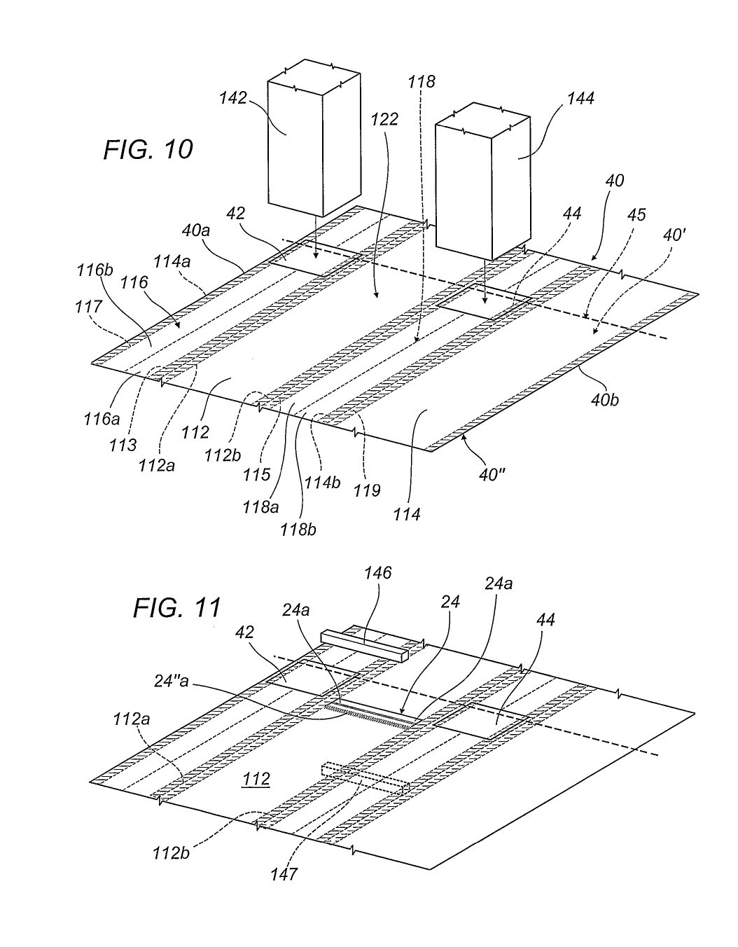

FIGS. 10 to 18 illustrate the different steps of a preferred method used to make the first embodiment of the bag described above.

This preferred method, which is preferably implemented by a single apparatus, comprises a step of unwinding a flat web of plastic or plasticised film 40 from a roll, not illustrated in the accompanying drawings, where said film has a heat-sealable face 40′ and an opposite face 40″ which is not heat-sealable and which is printed with appropriate writing, colours and images on predetermined areas of it, corresponding to predetermined parts of the front, rear and side faces of the bag.

The plastic film 40 may be fed either continuously or intermittently with steps of advancing the film alternated with steps of stopping the film, the cutting and sealing operations being carried out while the film is stopped.

As illustrated, the layered film 40 is unwound in a flat condition with its opposite longitudinal edges 40a, 40b parallel to the direction of feed.

This method comprises a step of making in the film 40 the openings 42, 44 transversally aligned with each other on the extension of the respective longitudinal areas or strips 116, 118 of the film 40 itself that will form the pleated sides 18, 16 of the bag.

As shown in FIG. 10, the openings 42, 44 have a quadrangular shape and are made by suitable cutting elements or punches 142, 144 which move up and down and which preferably cut the openings 42, 44 during the step in which the film 40 is not being advanced.

In the next station or step of this method, illustrated in FIG. 11, suitable fastening means 24 that can be opened and closed and consist of a zip of the type described above are applied to, or positioned on, the film.

In FIG. 11, the means that position the transversal zip 24 are not illustrated in detail.

It will be understood, however, that these means may operate in any suitable manner, moving the zip either transversally or perpendicularly to the film and allowing it to be cut to the required length from a continuous tape of zip unwound from a roll.

The zip 24 is fed to the film in the closed condition, that is to say, in a condition in which its interlocking parts 24a and 24b are engaged.

As illustrated, the zip 24 is positioned in the space between the punched openings or holes 42, 44 on a part 112 of the film 40 that will form the front wall of the bag.

To attach the transversal zip 24 to the film 40, suitable joining or sealing means 146, 147, positioned opposite each other, move vertically towards and against the film, and vice versa, in such manner as to seal the lower flap 24″a of the zip 24 (that is, the flap positioned downstream relative to the direction of feed) to the corresponding upper face 40′ of the film.

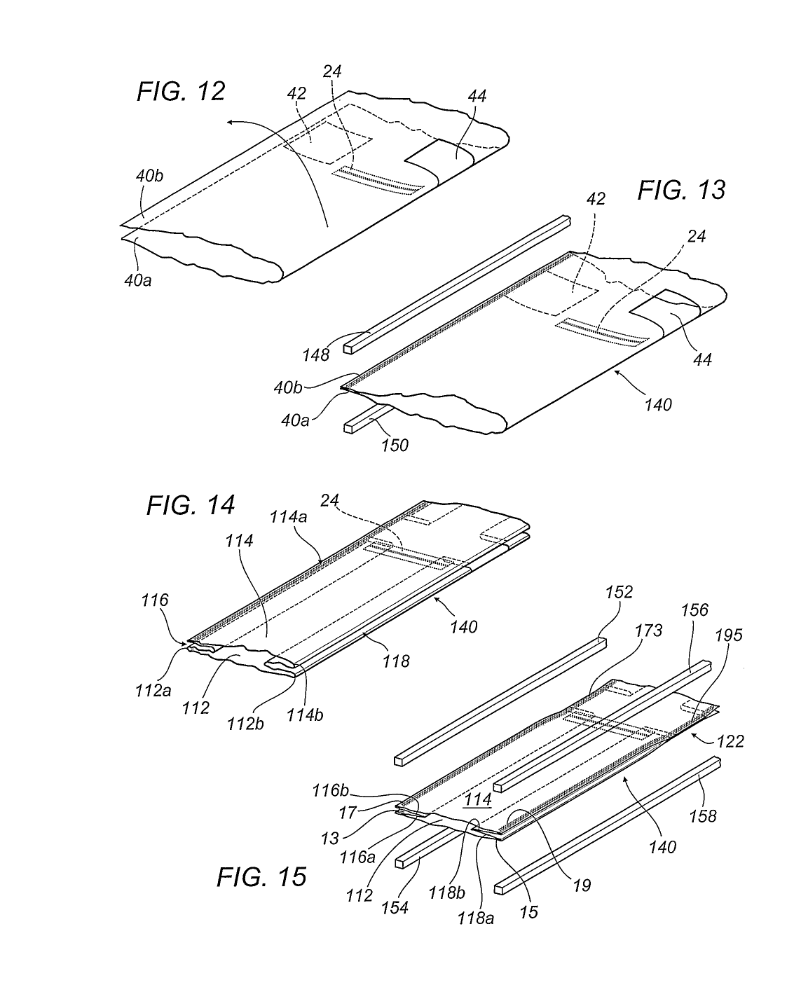

FIG. 12 shows the next step or station for forming the film into a tubular shape, where the edges 40a and 40b of the film are juxtaposed by a rotational movement that positions one transversal portion of the film over the other part. FIG. 13, on the other hand, illustrates opposite sealing means, labelled 148 and 150, for joining the longitudinal strips at the juxtaposed longitudinal edges 40a, 40b. The operations illustrated in FIGS. 12 and 13 impart a tubular shape to the film.

In the next step or station, illustrated in FIG. 14, the V-shaped pleated portions are formed in the tube of film.

In this condition, the film tube 140, according to this preferred embodiment, is divided into side portions 116, 118, which form the respective pleated sides of the finished bag, and intermediate transversal sides 112, 114, which form the front and rear walls 12 and 14 of the bag. In the accompanying drawings, the blades or means for forming the pleats in the film are not illustrated in detail.

As illustrated, when the side pleats have been formed, the film tube 140 is defined by end edges 112a, 112b and 114a, 114b, that respectively join the part 112 of the film that will form the front wall 12 of the bag and the respective portion 116, 118 that will form one pleated side of the bag to the part 114 of the film that will form the rear wall 14 of the bag and the respective portion 116, 118 that will form the other pleated side. These folding or joining lines 112a, 112b and 114a, 114b are drawn in dashed line style in FIG. 10.

In FIG. 15, the reference numerals 152, 154, 156, 158 denote sealing elements positioned opposite each other in pairs, which move vertically towards and against each other and towards and against the lateral edges of the film tube 140 in such a way as to tighten the longitudinal or lateral end strips of the film tube 140 to form respective joining or sealing strips labelled 13, 15, 17 and 19 in the drawings.

As illustrated, the longitudinal end sealing strips are the strips 13 and the strips 15 made between the film portion 112 that will form the front face 12 of the bag and the corresponding portion 116a, 118a of the pleats.

The longitudinal lateral sealing strips 17 and 19 are in turn made between the ends of the film portion 114 that will form the rear wall 14 of the bag and the corresponding portion 116b, 118b of the pleats.

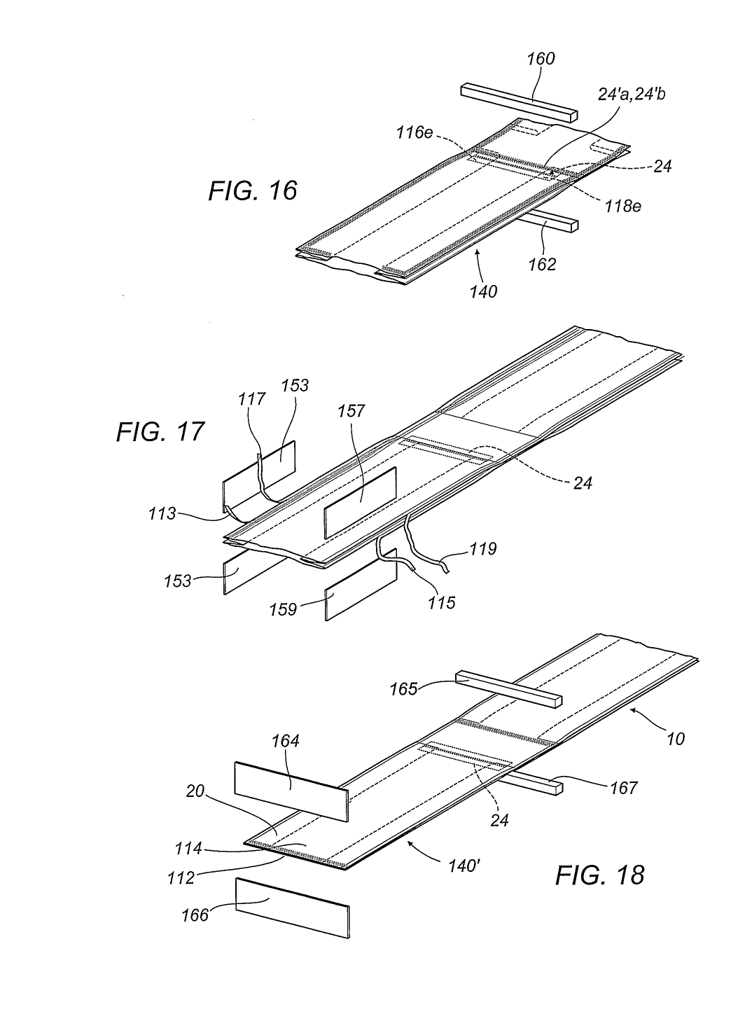

In the next step or station, illustrated in FIG. 16, the remaining flaps 24′a and 24′b of the zip 24 are sealed by respective sealing elements 160, 162 to the respective front wall 12 and rear wall 14.

In this step, means are also provided for sealing the upper end of the respective pleat 18, 16, that is to say the end of the pleat that is downstream relative to the feed direction. Thus, in this condition, the means for sealing the pleats 18, 16 comprise respective side portions of the opening/closing means or zip 24, which are positioned over the respective ends 116e, 118e of the pleats, thus closing the ends against the opposite intermediate wall 114, forming the rear wall 14 of the bag and thus sealing off the inside of the bag from the surrounding environment.

In the next step or station, illustrated in FIG. 17, suitable means or facing elements 153, 155, 157, 159 for cutting the film longitudinally, which move vertically towards and against the film, and vice versa, and remove the longitudinal ends of the sealed side strips 13, 15, 17, 19 at the lateral edges of the future bag. The longitudinal edges that are trimmed are labelled 113, 115, 117 and 119 in FIGS. 10 and 17.

The reference numerals 164, 166 in FIG. 18 denote transversal joining means or elements that move towards each other against the film tube in such a way as to make the transversal seals 20 to form the bottom of the bag. At this point, a bag web 140′ is formed downstream of the area where the transversal seals 20 are made.

In the next step or station, illustrated for convenience in FIG. 18, transversal cutting means 165, 167 located just downstream of the transversal sealing means cut each bag 10 at the seal 20 to separate it from the continuous bag web 140′.

Thus, according to a particularly advantageous aspect of this preferred embodiment of the method, the invention contemplates the provision of longitudinal joining or sealing strips, labelled 13, 15, 17 and 19 in the drawings, made between respective longitudinal end or lateral portions or areas of the respective film side portions, labelled 116a, 116b, 118a, 118b in the drawings, and respective longitudinal lateral end areas of the respective intermediate film portions 112, 114, said sealing areas 13, 15, 17 and 19 defining the lateral seals 30, 32, 34, 36 of the finished bag.

Further, longitudinal lateral end areas 173, 195 of the juxtaposed intermediate film portions 112, 114 that will form the front and rear walls of the finished bag are sealed directly to the extension of the longitudinal joining or sealing strips 13, 15 17 and 19 at a longitudinal area 122 of the film that will form the mouth 22 of the bag, these seals forming the lateral seals 26 and 30 of the tubular mouth when the bag is finished.

This method also makes it possible for the film to be guided more easily and accurately in the machines that make the bags, thus improving the quality of the bags.

Further advantageously, according to this method, the outer longitudinal edges of the joining strips 113, 115, 117, 119 are trimmed so that the edges of the lateral sealed portions 26, 28, 30, 32, 34, 36 of the front wall 12, rear wall 14, and side walls 16 and 18 of the finished bag are neatly cut and well aligned and thus obtaining a good quality bag with a high-precision finish.

The latter operation, which better defines the sides of the film tube as it advances, also enables the film to be laterally guided more effectively as it moves along the production line, with the added advantage of better quality and precision finish of the bags.

The neat finish obtained by cutting off or trimming the longitudinal edges 113, 115, 117, 119 of the film tube makes the finished bags highly appreciated on the market.

According to another advantageous aspect, well illustrated in FIG. 10, the invention contemplates the provision of closing means 24, which are positioned transversally to the film 40 and which are equal in length to the front and rear walls 12, 14 of the finished bag, the ends 24e, 24e of the closing means 24 being spaced from the imaginary folding line 112a, 112b of the respective edge of the pleat.

This, compared to prior art, reduces the amount of material needed to make the zips 24 relative to the size of the film. Also, there is no appreciable loss of bag volume available for the containment of product.

The width of the lateral joining strips 13, 15, 17, 19 may be between 5 and 15 mm, whilst the longitudinal trimming edges 113, 115, 117, 119 may be between 0.5 and 6 mm in width.

As may be inferred from the above, the joins between the inside surfaces 40′ of the bag are preferably made by heat sealing.

In particular, the longitudinal lateral seals of the bag are made by sealing bars mounted opposite each other and equal to the bag in length. Sealing bars of different length are also imaginable, however.

When the film used to make the bags is fed with intermittent motion, the film feed step may be substantially equal to the length of a single bag or less than this by a predetermined multiple of this length. In the latter case, the length of the sealing bars would permit subsequent sealing of the longitudinal areas of the film.

According to the embodiment illustrated in particular in FIG. 10, the width of the transversally aligned openings 42, 44 that form the tubular mouth of the bag is larger than the final width of the respective pleat consisting of the width of the portions 18a, 18b and 16a, 16b of the pleats, respectively. This allows greater tolerance for positioning the film relative to the punches that make the openings 42, 44.

As illustrated, according to the first preferred embodiment of the method, the width of the openings 42, 44 is smaller than the width or transversal distance between the fold lines 112a, 114a e 112b, 114b along which the V-shaped pleats are formed in the film tube.

The reference numeral 45 in FIG. 10 denotes a transversal cutting line along which adjacent bags are separated. The cutting line 45 is made just downstream of the transversal sealing line defining the bag bottom 20 and, more specifically, is located substantially at the respective edge of the openings 42, 44.

In practice, the front and rear walls of a bag made using this method are slightly less wide than the respective transversal, portions 112, 114 of the film from which the front and rear walls are derived.

Similarly, the pleated sides 18 and 16 of the finished bag are slightly less wide than the film portions 116, 118 from which the pleated sides are formed.

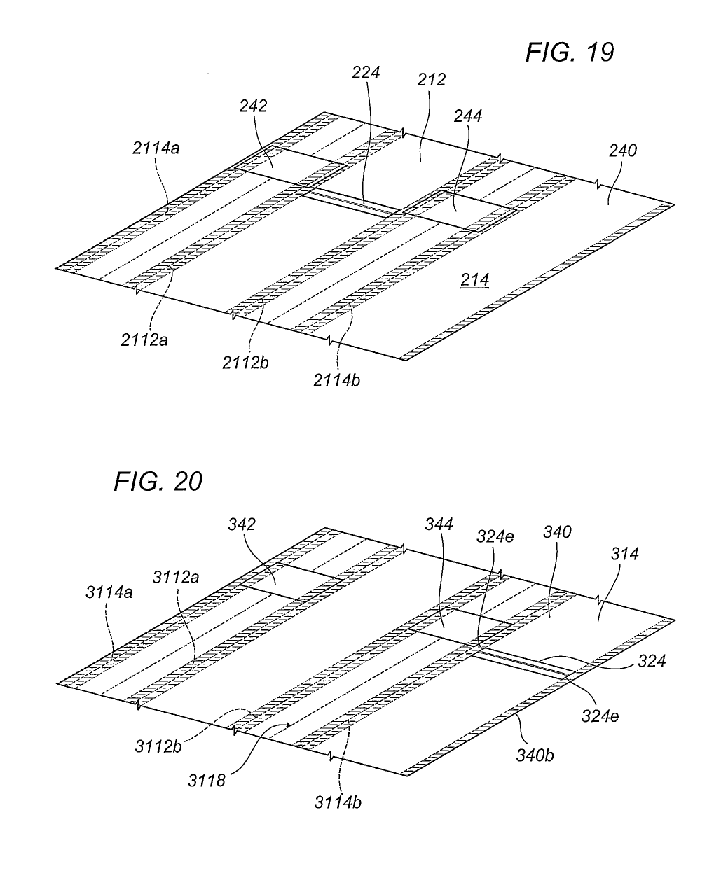

According to a third preferred method, illustrated in FIG. 19, the openings 242, 244 made in the film 240 when flat and defining the tubular mouth of the bag have a width that is larger than the transversal distance between the fold lines 2112a, 2112b, 2114a, 2114b of the film 240 portions which define a respective pleated side 216, 218 between the portions defining the front and rear walls 212, 214. This increases the working tolerance. The reference numeral 224 in FIG. 19 denotes a zip identical to the one of the previous preferred embodiment from which this embodiment differs essentially in the size of the openings 242, 244.

According to a fourth preferred method, illustrated in FIG. 20, the film 340 has transversally aligned openings 342, 344 made in it to form the tubular mouth of the bag, the width of said openings 342, 344 being equal to the transversal distance between the fold lines 3112a, 3112b, 3114a, 3114b on the film portion 340 and defining a respective pleated side of the bag. According to an advantageous aspect of the fourth preferred embodiment of the method for making flexible plastic bags, the invention contemplates the provision of transversally oriented closing means, or zip, 324 on the film portion 314 on the outer side of the openings 342, 344 that define the tubular mouth of the bag.

The zip 324 is substantially the same as the one described above and is slightly less wide than the portion 314 that forms the respective main wall of the bag, its ends 324e, 324e being spaced, respectively, from the longitudinal edge 340b of the film 340 and its other end 340e from the fold line 3114b of the portion 3118 defining a respective pleated side of the bag.

In the fourth preferred embodiment, as in the ones described above, the zip 324 constitutes suitable means for sealing the top end of the pleats.

In the fourth preferred embodiment, where the zip 324 is positioned on the outside of the holes 342, 344, it is possible, for example, to mount the means for applying the zip 324 at substantially the same position as the means for making the openings 342, 344, thus advantageously reducing the length of the machine or apparatus that makes the bags or bag web.

Another disadvantage of prior art bags is due to the fact that they are not perfectly sealed at the zip, whose supporting flaps are not impermeable to air, causing the food product inside the bag to deteriorate.

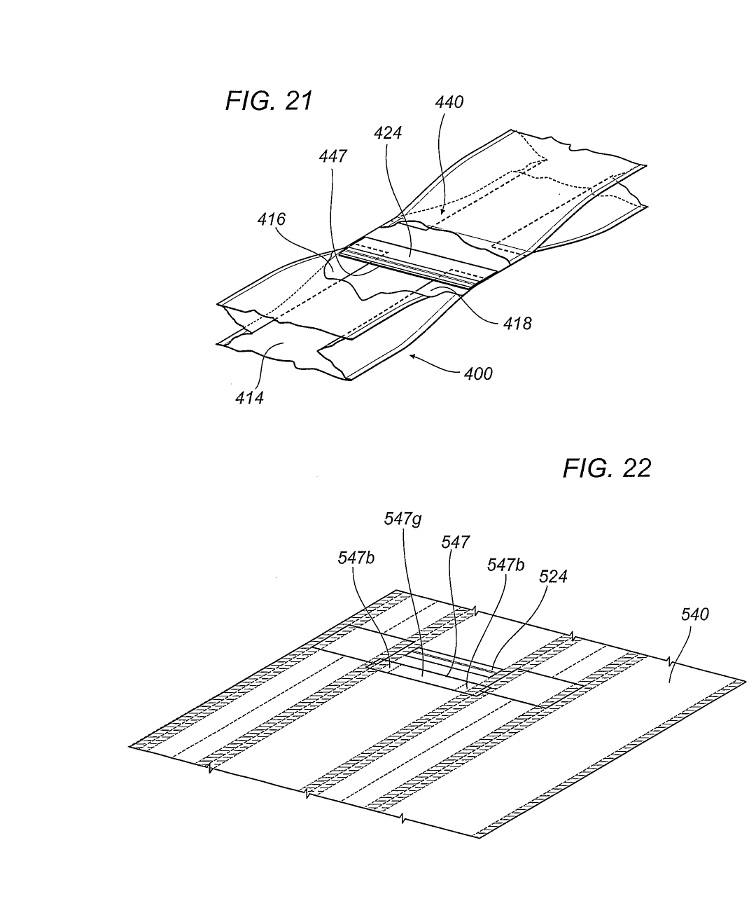

FIG. 21 illustrates a fifth preferred embodiment of the method for making a bag. This bag 400 advantageously comprises means for creating a barrier or hermetic seal against the outside environment. In practice, according to the fifth preferred embodiment of the method, a transversal strip or band 447 of film made of a suitable material impermeable to air is applied, said band 447 being applied at the zip 424. In particular, in the example shown in FIG. 21, the band 447 is applied below the zip, against the rear wall 414, in such manner as to seal off the upper end of the pleats 416, 418.

In practice, according to this fifth preferred method, when the zip 424 is positioned on the film 440, the band 447, having two adhesive or sealable faces, is applied over it with one of these joining faces placed in contact with and sealed to the upper face not resting on the film of the zip 424. Next, after the film 440 has been folded into a tubular shape and the V-shaped pleated sides have been formed, the face of the barrier means 447 can be applied to the other face of the other wall of the film 440 in such a way to hermetically seal off the upper surfaces of the pleated sides 416, 418.

The opening/closing zip 424 and the sealing band 447 may be applied to the film together or one after the other at different times and stages.

According to a sixth preferred embodiment, illustrated in FIG. 22, the invention contemplates the use of a band, in particular of barrier film 547, applied to the film separately from the zip. In this sixth preferred method the zip 524 can be placed at any suitable longitudinal position of the bag without losing the hermetic seal of the pleats.

The sealing band 547 can be made with one adhesive face applicable directly to the film 540, with side portions 547b and 547b designed to seal off the upper, or downstream, end of each pleat, and with a central portion 547g of the band 547 that is, or remains, non-adhesive so as to allow free access to the inside of the bag.

According to another preferred embodiment, not illustrated in the drawings, the barrier element might be made in any other suitable way, for example, consisting of a first and a second part joined to the juxtaposed faces of the front and rear walls of the bag which can then be separated to allow access to the inside of the bag.

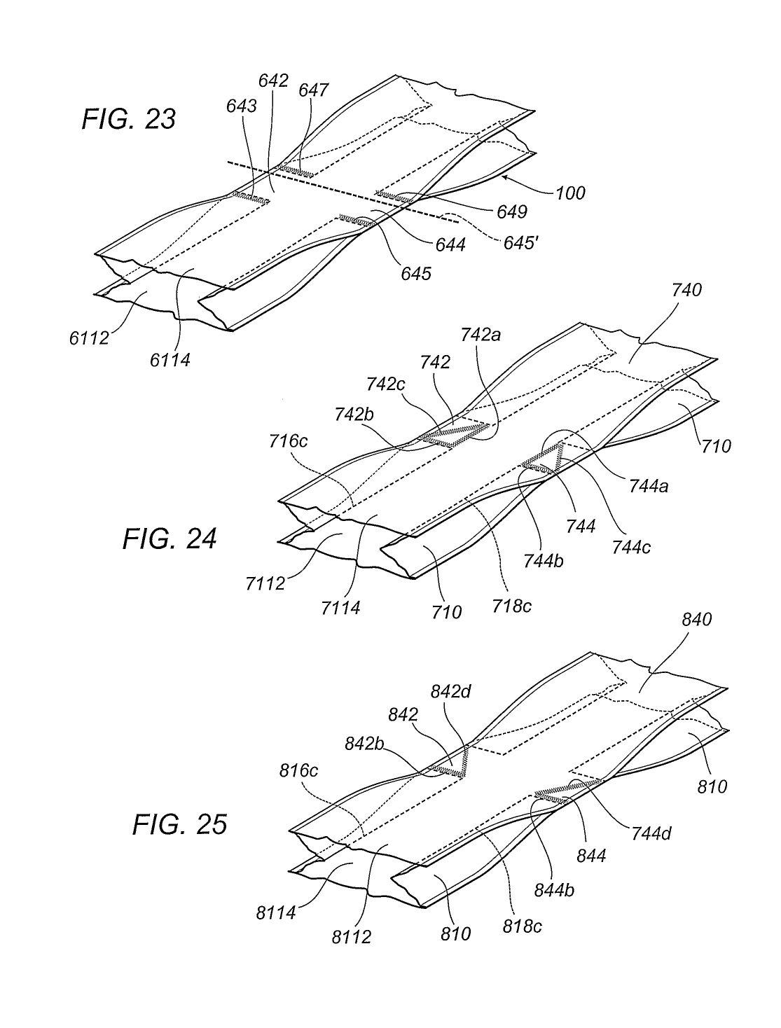

Other ways of sealing the pleated sides, independent of the opening/closing means are contemplated by the invention, as shown in FIG. 23.

FIG. 23 shows a seventh preferred method for making flexible bags in which the pleated sides are closed by sealing them at the openings 642, 644 that form the mouth at the top of the bag.

As illustrated, once the pleats have been formed, the lower section of the facing portions 6112 and 6114 of the film tube that will form the front and rear faces of the mouth are transversally sealed with two short transversal seals that are labelled 643 and 645 in FIG. 23.

In much the same way, corresponding seals 647, 649 can be made at the upper section of the film portions 6112, 6114 at the openings 642, 644 to close the pleats of the leading bag on the other side.

Next, a transversal seal can be made to define the bottom of the bag to be cut off along the transversal cutting line 645′.

FIG. 24 illustrates an eighth method for making flexible plastic bags with tubular mouth at the top of them. As shown in FIG. 24, at the transversally aligned openings 742, 744 defining the tubular mouth of the bag the film 740, which is folded to form a bag web 710, has suitable seals made between sealable or joinable opposite faces of the portions 7112 7114 that will form the respective front and rear walls of the bag.

More specifically, means for channeling the product out of the bag are provided at the opening 742, 744, said means consisting of a transversal, a longitudinal and an oblique portion connecting the free ends of the transversal and longitudinal portions.

The longitudinal sealing portions are labelled 742a and 744a. As illustrated, the longitudinal sealing portions 742a and 744a each have an upstream end from which a respective horizontal seal 742b, 744b extends, whilst the oblique seals 742c and 744c connect the ends opposite the ends joining the longitudinal and transversal seals.

In practice, the openings or lateral areas of the tubular mouth are provided with a sort of funnel, or means for channeling the product out of the bag, which narrows the outlet opening as far as the central folding line inside the pleat, labelled 716c, 718c, thus providing the bag 710 with a narrowed tubular mouth.

FIG. 25 illustrates a ninth preferred method for making flexible bags. In the ninth preferred embodiment, means for channeling the products in are provided at the lateral areas of the mouth at the top of the bag 810, where the openings 842, 844 are made in the film 840.

In this preferred embodiment, the funnel means have, only at the upstream section of the opening 842, 844, a transversal sealing portion between the walls 8112 8114 and extending as far as the folding edge inside the pleat 816c, 818c.

These transversal seals 842b and 844b define a narrowed section and, if necessary, like the above mentioned transversal seals 742b and 744b of the previous preferred embodiment, may also define means for sealing the tops of the pleated sides of the bag.

Oblique portions 842b and 844b, flaring towards the front or upper part of the bag, extend from the inside end of the transversal seals 842b and 844b. These oblique portions 842b and 844b connect respective ends of the quadrangular area 842, 844 which is substantially defined by half the transversal dimension of the tubular mouth openings made in the film 840 when it is flat.

The oblique portions 842d, 844d flared towards the outside of the bag 810 form a sort of funnel that facilitates filling of the bag.

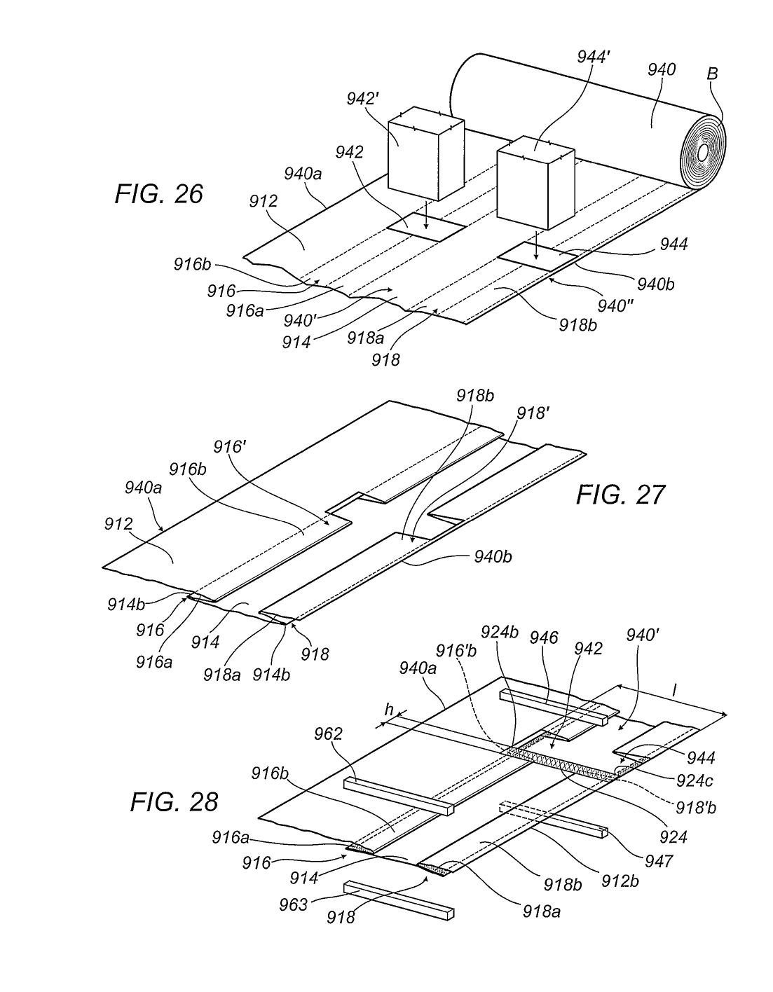

A tenth preferred method, illustrated in FIGS. 26 to 35, which is preferably implemented by a single apparatus or production line to make a bag according to the second embodiment shown in FIG. 4, comprises a step of unwinding a flat web of plastic or plasticised film 940 from a roll B, where said film has a heat-sealable face 940′ and an opposite face 940″ which is not heat-sealable and which is printed with appropriate writing, colours and images on predetermined areas of it, corresponding to predetermined parts of the front, rear and side faces of the bag.

The plastic film 940 may be fed either continuously or intermittently with steps of advancing the film alternated with steps of stopping the film, the cutting and sealing operations being carried out while the film is stopped.

The layered film 940 is unwound in a flat condition with its opposite longitudinal edges 940a, 940b parallel to the direction of feed.

This method comprise a step of making in the film 940 the openings 942, 944 transversally aligned with each other on the extension of the respective longitudinal areas or strips 916, 918 of the film 940 itself that will form the pleated sides 16, 18 of the bag.

As shown in FIG. 26, the openings 942, 944 have a quadrangular shape made by suitable cutting elements or punches 942′, 944′ which move up and down and which preferably cut the openings 942, 944 during the step in which the film 940 is not being advanced.

In the next station or step of this method, illustrated in FIG. 27, the V-shaped pleated portions are formed in the flat film.

In this condition, the flat film 940, according to this preferred embodiment, is divided into side portions 916, 918, which form the respective pleated sides of the finished bag, and intermediate transversal sides 912, 914, which form the front and rear walls 12 and 14 of the bag. In the accompanying drawings, the blades or means for forming the pleats in the film are not illustrated in detail.

As illustrated, in this condition, the pleated portion 916 is defined by a folding edge 914a which joins the part 914 of the film that will form the rear wall 14 of the bag to the corresponding portion 916a that will form the pleated side 16 of the bag. Also, in this condition, the other section 916b of the portion that will form the pleated side 16 extends in the same plane as the part 912 of the film that will form the front wall 12 of the bag.

As illustrated, in this condition, the pleated portion 918 is defined by a folding edge 914b which joins the part 914 of the film that will form the rear wall 14 of the bag to the corresponding portion 918a that will form the pleated side 18 of the bag. Also, in this condition, the other section 918b of the portion that will form the pleated side 18 extends freely outwards and ends with an edge 912b that will be attached to the lateral portion 940a of the part 912 that will form the front wall 12 of the bag.

In practice, according to the tenth embodiment, the pleated sides of the film are formed before the film is made into a tubular shape.

As illustrated, the first and second indented pleated portions 916, 918 have respective ends 916′, 918′ to be hermetically closed or sealed, as described in more detail below.

In the next station or step of this method, illustrated in FIG. 28, sealing means 924, in the form of a band or strip, preferably of suitable heat-sealable material, especially a material that is heat-sealable on both of its faces, is applied to, or positioned on, the film.

In FIG. 28, the means that position the transversal band 924 are not illustrated in detail. It will be understood, however, that these means may operate in any suitable manner, moving the band either transversally or perpendicularly to the film and allowing it to be cut to the required length from a continuous tape unwound from a roll (not illustrated in the accompanying drawings). Obviously, a band feeder designed to feed bands 924 that have been pre-cut to the required length might also be used.

As illustrated, the band 924 is positioned in the space between the punched openings or holes 942, 944, with the pleated portions in the folded condition, on a part 914 of the film that will form the rear wall of the bag and positioned over the end portions 916′b and 918′b of the upper pleated portions 916b, 918b.

To attach the transversal band 924 to the film 940, suitable joining or sealing means 946, 947, positioned opposite each other, move vertically towards and against the film, and vice versa, in such manner as to seal the band 924 to the corresponding upper face 940′ of the film and to the portions 916′b, 918′b of the sections 916b, 918b of the V-shaped folded portions that will form the pleated sides 16 and 18, which are connected to the front wall 12 of the bag. In this way, the respective end 916′, 918′ of the pleated portions are sealed.

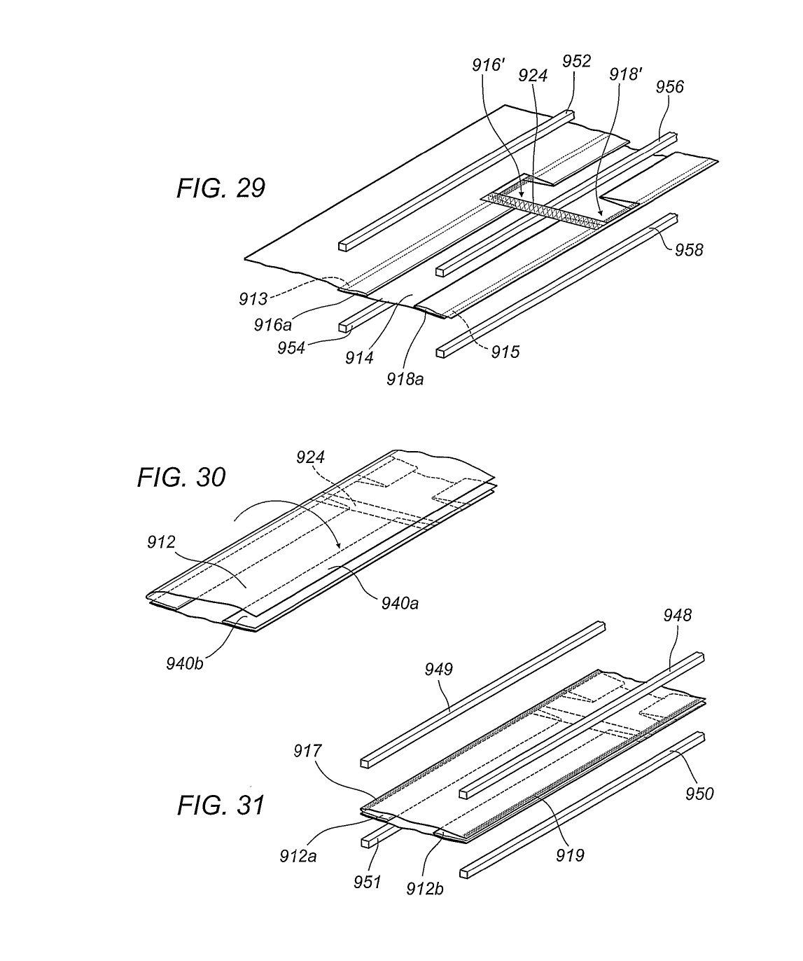

The sealing band 924 has a length “l”, a height “h” and a first and second opposite longitudinal faces, of which only one, labelled 924a, is illustrated in FIG. 29. Preferably, the face 924a is of the sealable type, like the face opposite it, which is sealed to the upper face 914 of the film above the ends 916′b and 918′b of the pleats, so that a part of the height of the strip remains above the respective pleats and a part is connected to the film face 914 at the edges of the pleats, thereby sealing the respective end of the pleats.

The strip or band 924 may be made in any suitable way: for example it may consist of a single film of polythene or similar material that can be sealed to the film the bag is made of, or it may consist of a layered material consisting of two layers, one layer of polythene and another layer of polyester or other similar material that can be sealed to the film the bag is made of.

Since the band 924 can be sealed both by its lower face, which comes into contact with the film face 914, and by its upper face 924a, it is possible, as explained below, to seal its upper face 924a to the corresponding film face 912 at the lateral ends 924b, 924c of the band 924, thereby imparting added strength to the seal at these lateral areas.

The reference numerals 962, 963 in FIG. 28 denote transversal sealing or joining means or elements that move towards each other against the film tube in such a way as to make the transversal seals to form the pleats at the bottom of the bag.

More specifically, the portions 916a, 918a are sealed to the central portion 914 at the bottom of the bag. This transversal seal by which the lower ends of the pleats at the bottom of the bag are attached to the wide portion 914 makes film feed more stable and easier to control.

In FIG. 29, the reference numerals 952, 954, 956, 958 denote longitudinal sealing elements positioned opposite each other in pairs, which move vertically towards and against each other and towards and against the respective longitudinal edges of the film tube 940 in such a way as to form respective joining or sealing strips labelled 913, 915 in the drawings. As illustrated in FIG. 29, the longitudinal end strips are the strips 913 and the strips 915 made between the film portion 914 that will form the rear face 914 of the bag and the corresponding portion 916a, 918a of the pleats. Thus, film feed is more stable and easier to control.

FIG. 30 shows the next step or station for forming the film into a tubular shape, where the edges 940a and 940b of the film are juxtaposed by a rotational movement that positions one transversal portion 912 of the film over the other part. This forms a tube of film with V-shaped pleated side portions, as shown in FIG. 31.

FIG. 31 illustrates opposite sealing means, labelled 948 and 950, for joining the longitudinal strips at the juxtaposed longitudinal edges 940a, 940b to create a longitudinal sealed strip 919. At the same time, opposite sealing means 949 and 951 make a longitudinal sealed strip 917 on the opposite side. In practice, this step makes longitudinal strips 917, 919 along the edges where the pleated portions 916b, 918b are joined to the portion 912 that will form the front wall 12 of the bag.

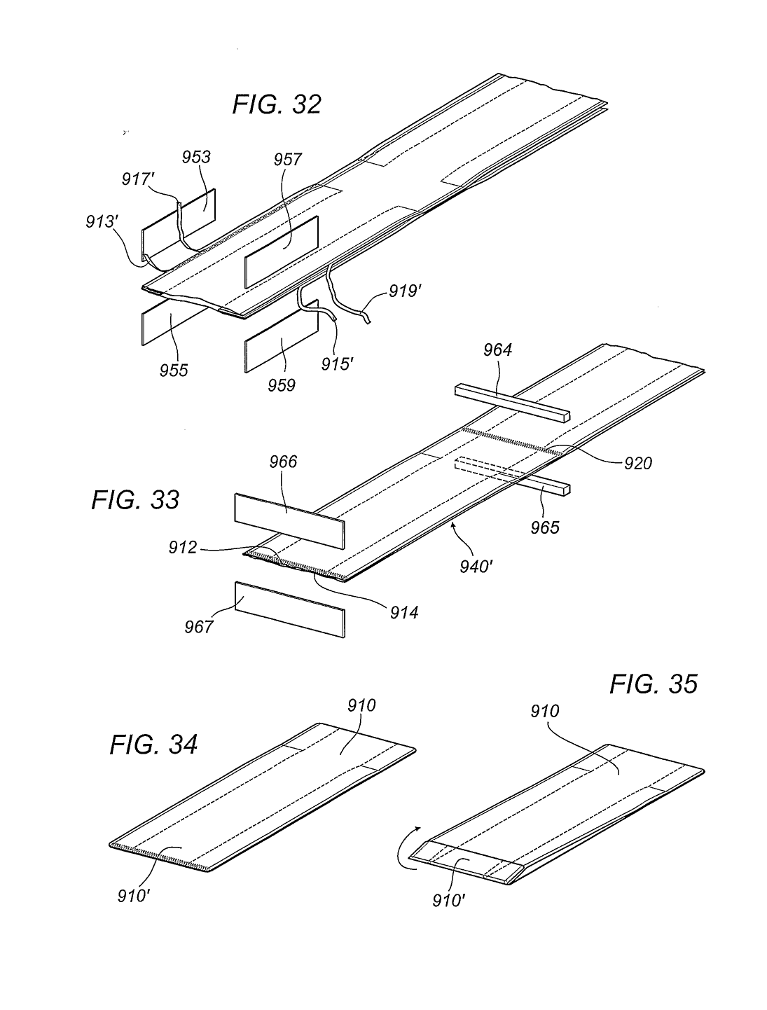

In the next step or station, illustrated in FIG. 32, suitable means or facing elements 953, 955, 957, 959 for cutting the film longitudinally, which move vertically towards and against the film, and vice versa, and remove the longitudinal ends of the sealed side strips 913, 915, 917, 919 at the edges of the bag. The longitudinal edges are labelled 913′, 915′, 917′ and 919′ in FIG. 32. The width of the lateral joining strips 913, 915, 917, 919 may be between 5 and 15 mm, whilst the longitudinal trimming edges 913′, 915′, 917′, 919′ may be between 0.5 and 6 mm in width.

The reference numerals 964, 965 in FIG. 33 denote transversal joining means or elements that move towards each other against the film tube in such a way as to make the transversal seals 920 to form the bottom of the bag. At this point, a bag web 940, is formed downstream of the area where the transversal seals 920 are made.

In the next step or station, illustrated for convenience in FIG. 33, transversal cutting means 965, 967 are provided for cutting each bag 910, illustrated in FIG. 34, at the seal 920 to separate it from the continuous bag web 940′.

The bag 910 has a transversal bottom portion 910′ which may be folded onto and glued to the corresponding outside surface of the bag, as illustrated in FIG. 35, thus forming a wide bottom on which the bag can stand.

As may be inferred from the above, the joins between the inside surfaces 940′ of the bag are preferably made by heat sealing.

This method offers advantages similar to those of the methods described previously and, in particular, where applicable, those of the method illustrated in FIGS. 10 to 20. For brevity, however, these advantages are not described again.

In another step that is not illustrated, a zip might also be applied either directly to the band 924 or, alternatively, longitudinally spaced from the band 924 in the direction of the bag top or in the direction of the bag bottom.

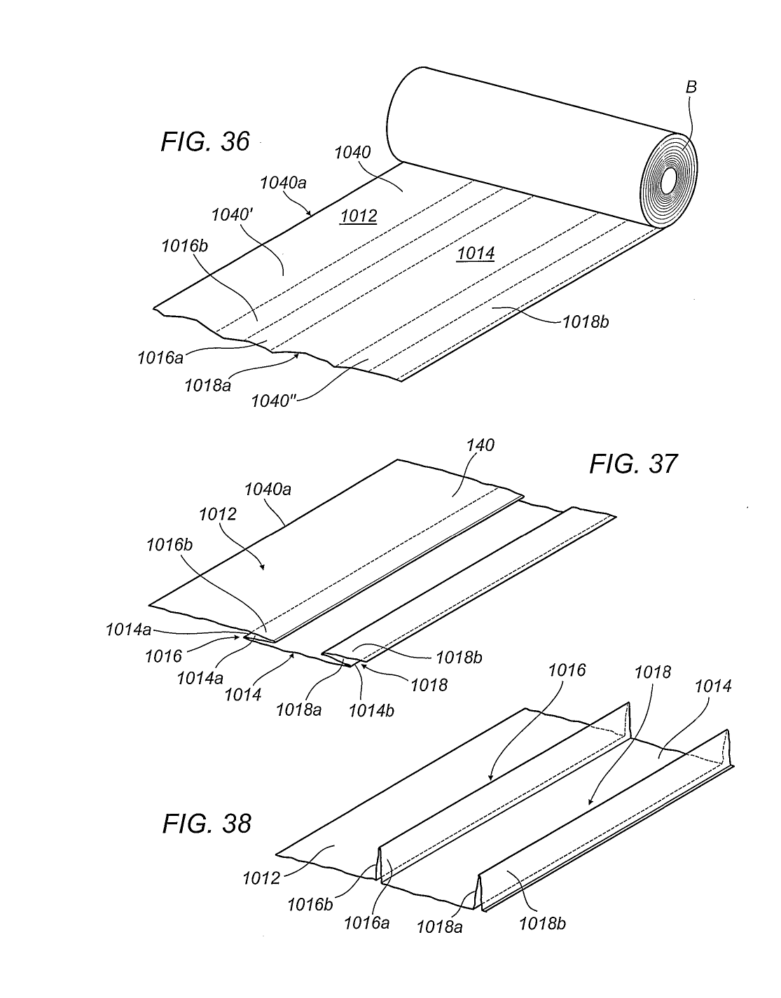

FIGS. 36 to 40 illustrate an eleventh preferred method for making bags. This embodiment of the method has several steps in common with the tenth embodiment of the method and these will not be described in detail again.

The eleventh preferred embodiment of the method, as illustrated in FIG. 36, comprises a step of unwinding a web of plastic or plasticised film 1040 from a roll B, where said film has a heat-sealable face 1040′ and an opposite face 1040″ which is not heat-sealable and which is printed with appropriate writing, colours and images on predetermined areas of it, corresponding to predetermined parts of the front, rear and side faces of the bag.

As in the tenth preferred embodiment, the plastic film 1040 may be fed either continuously or intermittently with steps of advancing the film alternated with steps of stopping the film, the cutting and sealing operations being carried out while the film is stopped.

Unlike the tenth embodiment, however, in the next station or step of the eleventh preferred embodiment of the method, illustrated in FIG. 37, V-shaped pleated portions are formed in the flat film.

In this condition, the flat film 1040, according to this preferred embodiment, is divided into side portions 1016, 1018, which form the respective pleated sides of the finished bag, and intermediate transversal sides 1012, 1014, which form the front and rear walls 12 and 14 of the bag. In the accompanying drawings, the blades or means for forming the pleats in the film are not illustrated in detail.

As illustrated, in this condition, the pleated portion 1016 is defined by a folding edge 1014a which joins the part 1014 of the film that will form the rear wall 14 of the bag to the corresponding portion 1016a that will form a pleated side of the bag. Also, in this condition, the other section 1016b of the portion that will form the pleated side 1016 extends in the same plane as the part 1012 of the film that will form the front wall 12 of the bag.

As illustrated, in this condition, the pleated portion 1018 is defined by a folding edge 1014b which joins the part 1014 of the film that will form the rear wall 14 of the bag to the corresponding portion 1018a that will form a pleated side of the bag. Also, in this condition, the other section 1018b of the portion that will form the pleated side 1018 extends freely outwards and ends with an edge 1012b that will be attached to the lateral portion 1040a of the part 1012 that will form the front wall 12 of the bag.

In the next station or step of this method, illustrated in FIG. 38, the V-shaped pleated portions are erected. More specifically, the portions 1016a, 1016b and 1018a, 1018b are erected so they are substantially perpendicular to the flat portions 1012, 1014 of the film.

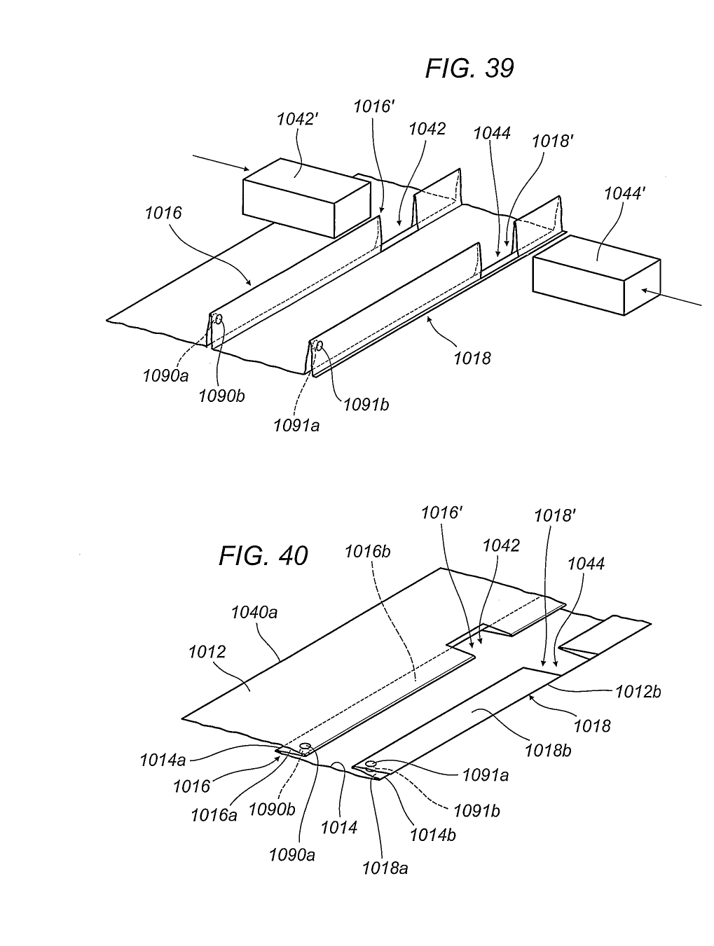

As shown in FIG. 39, in the next station or step, the method comprises a step of making in the film 1040 the openings 1042, 1044 transversally aligned with each other in the erected longitudinal areas or strips 1016a, 1016b and 1018a, 1018b of the film 1040 that will form the pleated sides 16, 18 of the bag.

As shown in FIG. 39, the openings 1042, 1044 have a quadrangular shape and are made by suitable cutting elements or punches 1042′, 1044′, illustrated schematically, which move transversally or horizontally, backwards and forwards, and which preferably cut the openings 1042, 1044 during the step in which the film or web 1040 is not being advanced.

As illustrated, the punching operation results in indented pleated portions 1016, 1018 whose respective ends 1016′, 1018′ must be hermetically closed or sealed, as in the tenth preferred embodiment described above.

At this stage or at a later stage, openings 1090a, 1090b, 1091a, 1091b, in the form of holes, and in particular, round holes, might also be made in a respective pleated portion 1016a, 1016b and 1018a, 1018b, said holes being made by punches which are not illustrated in the accompanying drawings. The holes 1090a, 1090b and 1091a, 1091b are exactly aligned with each other.

Obviously, the holes 1090a, 1090b, 1091a, 1091b might also be made in a film used to make pleated bags different from the ones described here, for example bags without the openings 1042, 1044.

In the next station or step of this method, illustrated in FIG. 40, the V-shaped pleated portions are formed in the remaining part of the flat film. In practice, the portions 1016a, 1016b and 1018a, 1018b are folded down again so as to return to the condition shown in FIG. 37. More specifically, the portions 1016a, 1018a are moved back down into contact with the film portion 1014 that will form the rear wall of the bag.

The bag making method according to this embodiment then proceeds in the same way as the tenth preferred embodiment illustrated in FIGS. 28 to 35.

In the eleventh embodiment of the method, the pleated sides are formed before making the openings 1042, 0144. The openings obtained are especially precise and accurate.

The film for making the bag according to the invention is preferably a layered film comprising a layer of aluminium and a layer of plastic, whilst the barrier film is also made of a layered material comprising a layer of plastic impermeable to gas, especially gases present in air. The zip is also made of a suitable plastic material.

According to the invention, the bag is designed in particular to be made in the flattened condition illustrated in FIG. 1 on a machine extending longitudinally. However, the bag might also be made in a bag form, fill and seal production line.

The bags may be supplied to a production company where they are opened, filled with product and sealed at the top.

The bags may be made to any required height, advantageously optimising their containing capacities.

The film preferably consists of a layered plastic material which may, if necessary, also include a layer of aluminium foil or other metallised material. The material from which the film is made, however, is well within the knowledge of an expert in the trade and is not described in detail.

It will be understood that the invention described may be useful in many industrial applications and may be modified and adapted in several ways without thereby departing from the scope of the inventive concept. Moreover, all the details of the invention may be substituted by technically equivalent elements.

1-59. (canceled)

60. A method for making bags, preferably of flexible plastic film, comprising steps of feeding a sheet of film, preferably of a suitable plastic material; making in said film at least one indented pleated portion and, in particular, a first and a second indented pleated portion (916, 918), where each indented pleated portion has a respective longitudinal end (916′, 918′); and forming the film into a tubular shape; the method wherein means are provided for sealing the respective end (916′, 918′) of the pleated portion; and wherein said means for sealing the respective end (916′, 918′) of the indented pleated portion (916, 918) are in the form of a respective sealing band (924).

61. The method according to claim 60, wherein the sealing band (924) is a band of material that is heat-sealable on both of its faces.

62. The method according to claim 60, wherein the sealing band (924) consists of a single band extending in such manner as to seal off the longitudinal ends (916′, 918′) of both the indented pleated portions (916, 918).

63. The method according to claim 60, wherein one longitudinal end (916′, 918′) of the respective indented pleated portion (916, 918) is sealed off with sealing means (942) before the film (940) is formed into a tubular shape.

64. The method according to claim 60, wherein one longitudinal end (116e, 118e) of the respective indented pleated portion (116, 118) is sealed off with sealing means (24) after the film (40) has been formed into a tubular shape.

65. The method according to claim 60, wherein means (924) for sealing the respective end (916′, 918′) of the indented pleated portion are applied to the film after the indented pleated portion (916a, 916b, 918a, 918b) has been formed.

66. The method according to claim 60, wherein the indented pleated portion (116a, 116b, 118a, 118b) is formed next to the step of applying of the means for sealing the respective end (116e, 118e) of the indented pleated portion.

67. The method according to claim 60, wherein the respective indented pleated portion (916a, 916b, 918a, 918b) is formed before the film (940) is formed into a tubular shape.

68. The method according to claim 60, wherein the respective indented pleated portion (116a, 116b, 118a, 118b) is formed after the film (940) has been formed into a tubular shape.

69. The method according to claim 60, wherein an opening (1042, 1044) is made in the film in the part of the film defining the indented pleated portion (1016, 1018), said opening (1042, 1044) being made after the indented pleated portion (1016, 1018) has been formed.

70. The method according to claim 60, wherein an opening (242, 244) is made in the film in the part of the film defining the indented pleated portion, the width of said opening (242, 244) being larger than the transversal distance between the fold lines (2112a, 2114a, 2112b, 2114b) of the part of the film (240) that defines a respective pleat.

71. The method according to claim 60, wherein an opening (016, 017) is made in the film in the part of the film defining the pleated portion (014, 015); the width of said opening (016, 017) being smaller than the transversal distance between the fold lines of the part of the film that defines a respective pleat (014, 015).

72. The method according to claim 60, wherein the part of the film defining the pleated portion (1016, 1018) is erected with respect to the plane defined by the film as it advances.

73. The method according to claim 72, wherein the openings (1042, 1044, 1090a, 1090b, 1091a, 1091b) are made in the respective pleated portions (1016, 1018) when these are in the erected condition.

74. The method according to claim 72, wherein the pleated portion (1016, 1018) is re-lowered to the plane defined by the film as it advances.

75. The method according to claim 60, wherein at least one longitudinal strip (13, 913) joining respective longitudinal end or lateral areas of the film tube is made.

76. The method according to claim 75, wherein a second longitudinal strip (15, 915) joining respective longitudinal end or lateral areas of the film tube is made.

77. The method according to claim 75, wherein the longitudinal strip (913, 915) joining respective longitudinal end or lateral areas of the film tube is made before the film is formed into a tubular shape.

78. The method according to claim 75, wherein the longitudinal strip (13, 15) joining respective longitudinal end or lateral bands of the film tube is made after the film has been formed into a tubular shape.

79. The method according to claim 75, wherein at least a third longitudinal strip (17, 917) joining respective longitudinal end or lateral areas of the film tube is made after the film has been formed into a tubular shape.

80. The method according to claim 79, wherein a fourth longitudinal strip (19, 919) joining respective longitudinal end or lateral areas of the film tube is made after the film has been formed into a tubular shape.

81. The method according to claim 75, wherein a longitudinal strip (17, 919) joining respective longitudinal end or lateral areas of the film tube is made and defines means for longitudinally sealing the film tube.

82. The method according to claim 60, wherein a longitudinal joining strip (173, 195) is made in the areas (122) defining the mouth (22) of the bag, between respective longitudinal end areas of opposite intermediate film portions (112, 114).

83. The method according to claim 60, wherein at least one lateral longitudinal edge (113, 115, 117, 119) is trimmed from the film tube.

84. The method according to claim 83, wherein a plurality of outer longitudinal edges (113, 115, 117, 119) are trimmed from the film tube.

85. The method according to claim 83, wherein a respective outer longitudinal edge (113, 115, 117, 119) of the joining strips (13, 15, 17, 19) is trimmed from the main portion of the bag body.

86. The method according to claim 83, wherein a respective outer longitudinal edge (113, 115, 117, 119) of the joining strips (13, 15, 17, 19) is trimmed from the mouth portion of the bag body.

87. The method according to claim 75, wherein the lateral longitudinal joins consist of seals (13, 15, 17, 19).

88. The method according to claim 75, wherein the lateral longitudinal joins are made by opposing plates (152, 154, 156, 158) that come into contact with opposite faces of the film tube.

89. The method according to claim 88, wherein the length of the longitudinal sealing plates (152, 154, 156, 158) is substantially equal to the length of the bag (10).

90. The method according to claim 88, wherein the length of the longitudinal sealing plates (152, 154, 156, 158) is greater than the length of the feed step of the bag web.

91. The method according to claim 60, wherein a transversal joining strip is made between opposite wide intermediate portions (112, 114) of the film to define the bottom of the bag.

92. The method according to claim 90, wherein the film is separated along the transversal bottom join (40, 42) in such manner as to define the bottom of one bag and the mouth of the next bag.

93. The method according to claim 60, wherein a transversal joining strip is made between opposite indented pleated portions (916a, 918a) and a respective wide intermediate portion (914) of the film at the area defining the bottom of the bag before the film is formed into a tubular shape.

94. The method according to claim 60, wherein an opening (42, 44) is made in the respective indented pleated portion (16a, 16b, 18a, 18b), the width of said opening being larger than the final width of the respective pleat (16a, 16b, 18a, 18b).

95. The method according to claim 60, wherein the opening defining the mouth portion (40, 42) is quadrangular in shape.

96. The method according to claim 60, wherein means (24) for fastening the mouth (22) providing access to the inside of the bag are applied to the film, said fastening means being of the type that can be opened and closed.

97. The method according to claim 96, wherein the fastening means (24) have lateral ends (24e, 24e) that are transversally spaced from the fold lines (112a, 112b) of the portions (116, 118) defining the pleats.

98. The method according to claim 96, wherein fastening means (24) attached to one of the faces of the film (40) are provided.

99. The method according to claim 98, wherein the fastening means (24) are attached to the face of the bag or film tube opposite that on which they have been positioned on the film.

100. The method according to claim 96, wherein the fastening means (24) extend between the transversally aligned openings (42, 44) to form the tubular mouth of the bag.

101. The method according to claim 96, wherein the means for sealing off the outside environment and the opening and closing fastening means are placed over each other.

102. The method according to claim 96, wherein the means for sealing off the outside environment and the opening and closing fastening means are longitudinally spaced from each other.

103. The method according to claim 96, wherein the opening and closing fastening means are positioned on the film before the sealing means.

104. The method according to claim 96, wherein the fastening means are connected to a respective wall at a position above the top edge of the pleats so as to define means for sealing the pleats themselves.

105. The method according to claim 60, wherein the sealing band is made of sealing material on one face and of sealing material solely on the lateral parts that overlap the pleats.

106. The method according to claim 60, wherein the film has an upper face (40′) and a lower face (40″), where one face (40′) is suitably coupled or sealed and the other face (40″) is designed to form the exterior of the bag.

107. The method according to claim 60, wherein the respective indented pleated portion consists of an indented longitudinal portion of the film.

108. The method according to claim 60, wherein means for sealing the respective end of the indented pleated portion (16, 18) consist of barrier means.
